(19) United States
(12) Patent Application Publication
(10) Pub. No.: US 2003/0014558 A1
(43) Pub. Date: Jan. 16, 2003

(54) Batch interrupts handling device, virtual shared memory and multiple concurrent processing device

(75) Inventors: Makoto Amamiya, Fukuoka City (JP); Hideo Taniguchi, Fukuoka City (JP)

Correspondence Address: OLIFF & BERRIDGE, PLC, P.O. BOX 19928, ALEXANDRIA, VA, 22320, US

(73) Assignee: Kyushu University, Fukuoka City (JP)

(21) Appl. No.: 10/147,998

(22) Filed: May 20, 2002

(30) Foreign Application Priority Data
May 21, 2001 (JP) 2001-150738
Jul. 25, 2001 (JP) 2001-223837
Aug. 2, 2001 (JP) 2001-234611

(51) Int. Cl. G06F 9/46

(52) U.S. Cl. 709/318

(57) ABSTRACT

A batch interrupts handling device includes: means for generating an event or a message; means for holding contents of a certain number or a certain amount of events or messages; and means for performing a batch notification of the contents of a certain number or a certain amount of events or messages as an interrupt, and for performing a process of preserving software execution environment directly before the interrupt occurs, a process in accordance with the contents of a certain number or a certain amount of events or messages and a process of recovering the software execution environment directly before the interrupt occurs.

### BACKGROUND OF INVENTION

1. Technical Field

The present invention relates to a batch interrupts handling device and method, and a batch interrupts handling program executed by a computer, in which the batch interrupts handling is performed when a peripheral device notifies an arithmetic unit of an event or a message in a computer.

The present invention also relates to a virtual shared memory, a virtual shared storing method and a virtual shared storing program executed by a computer, for performing a multiple concurrent processing utilizing the principle of a multithread processing in order to make memories into a virtual memory which memories are used by various parallel and distributed computers connected to a network and are distributed among the computers (hereinafter, refer to “distributed memories”) as a shared memory in software and in order to efficiently perform a write and read operation to and from such a shared memory made virtual (hereinafter, refer to a “virtual shared memory”).

The present invention also relates to a multiple concurrent processing device, a multiple concurrent processing method, and a multiple concurrent processing program executed by a computer, which device, method and program are utilized in various concurrent and distributed computers connected to a network, and which device, method and program divide a conventional process into exclusively executable program pieces each called a thread by applying the principle of multithread processing, multiplex these program pieces and make them run concurrently, and thereby integrate processing of such an external event as communication or input/output and processing inside a computer and control a concurrent execution of them.

2. Background Art

A computer comprises an arithmetic unit and at least one peripheral device for notifying the arithmetic unit of an event or a message. In a conventional computer, in case that a peripheral device notifies an arithmetic unit of an event or a message, when events or messages to be notified have occurred, the arithmetic unit is immediately notified of each of them as an interrupt.

That is to say, in a conventional interrupt handling process in a computer, each time an event or a message to be notified has occurred, software for handling the interrupt is frequently executed. In a broad classification, the software for handling the interrupt performs three processes of; preserving software execution environment directly before the interrupt occurs; performing a process in accordance with contents of the interrupt; and recovering software execution environment directly before the interrupt occurs.

Among these three processes, the processes of preserving and recovering the software execution environment are performed each time the interrupt occurs regardless of the contents of the interrupt. These processes are not useful processes related to the contents of interrupt, but processes for preventing software execution environment from being changed by the occurrence of the interrupt, namely, these processes are a part of an overhead of the software for controlling a computer hardware. As a result, a conventional interrupt handling process has a disadvantage that the overhead is large by frequently performing the processes of preserving and recovering the software execution environment directly before the interrupt occurs.

In management of shared memories distributed among computers (hereinafter, refer to “shared distributed memories”), in case that a write operation and a read operation to and from a virtual shared memory are concurrently performed, it is necessary to give the read side a guarantee that correct data have been already written, and therefore it is necessary to perform a synchronization control between the write and read operations. In relation to such a synchronization control between write and read operations, up to now a user program issues explicitly a read instruction on the assumption that data have been already written into a memory to be referred to. For a read instruction issued, the prior art checks by means of the computer hardware or the operating system (OS) whether or not necessary data have been written into a memory to be read, and if a write operation has not been performed, it stands by for a read operation. Due to such a standby, an overhead for memory management occurs in a lock operation for controlling an exclusive access to a shared memory, a semaphore operation, an operation for keeping consistency in the contents among distributed memories, and the like. And in case that a write operation and/or a read operation is not accurate in timing, the standby time and/or the number of standbys in the read side is increased and thereby the overhead is increased. In a user program having a concurrent distributed processing described in it, a synchronization timing between a write operation and a read operation is described in advance in accordance with prediction, but in case that data to be read have not been written against prediction, the user program stands by until the data to be read are written, and thus a read operation not executable is issued and a standby occurs. It is difficult for a user program to accurately predict the synchronization between a write operation and a read operation in order to suppress the issue of a read operation not executable, and designing a program in consideration of the synchronization imposes a considerable burden to a user.

Each time an interrupt (an event) from outside occurs, a conventional event process suspends a program currently running and processes this interrupt with priority. In this case, it performs the changeover of an execution environment of a processor ordinarily called “context changeover”, stands by for the arrival of the event and thereafter restarts the program being suspended to run, and therefore its overhead is increased.

And in a conventional event process, it is necessary to design a program for controlling exactly the relation of timing between a program suspending to run as standing by for an event and the arrival of the said event. Particularly in concurrent and distributed processes, since a plurality of computers are concurrently operating as communicating with one another, events caused by communication or data transfer with other processors occur frequently. Since such events make complicated a mechanism for performing control of the order of execution of programs, namely, for performing a synchronization control among the programs on the respective processors, it is desired to simplify processing of programs.

A conventional event process of taking and processing an event just after it has arrived has the following problems in composition of computers and basic software, and in composition of programs for concurrent and distributed processes.

(1) Conventional computer hardware and operating systems (OS) aim mainly at making the overhead for context changeover as small as possible. Therefore, it is necessary to distinguish between an internal arithmetic operation process mainly performed by a user program and an event process generated by an external factor, and perform control paying attention to the changeover. This makes complicated the configuration of computers and the composition of basic software, and increases the cost of development.

(2) In description of a program, particularly in description of a concurrent and distributed processing program, it is required to design and describe a program so as to estimate the timing between an event standby and an event arrival, make mismatch in timing as small as possible, and make the number of context changeover operations as small as possible. Since a user designing and describing a concurrent and distributed process is required to describe the process in consideration of an external event and an internal arithmetic operation process with regard to each other, it is difficult for the user to describe a program as being devoted entirely to an algorithm for its original process, and thus the burden to a user's program description is remarkably increased.

An object of the present invention is to provide a batch interrupts handling device and method, and a batch interrupts handling program executed by a computer, capable of reducing the overhead furthermore at the time of the interrupt handling in a computer in comparison with the prior art by reducing the number of processes of preserving and recovering the software execution environment directly before the interrupt occurs.

Another object of the present invention is to provide a virtual shared memory, a virtual shared storing method and a virtual shared storing program executed by a computer, being capable of reducing an overhead.

Another object of the present invention is to provide a virtual shared memory, a virtual shared storing method and a virtual shared storing program executed by a computer, reducing a burden to a user.

Another object of the present invention is to provide a multiple concurrent processing device, a multiple concurrent processing method, and a multiple concurrent processing program executed by a computer, which device, method and program reduce an overhead for changeover of a program execution environment between execution and interrupt of a program without making complicated the configuration of computers and the composition of basic software, and without remarkably increasing the burden to a user's program description.

### DISCLOSURE OF INVENTION

A batch interrupts handling device according to the present invention comprises:

means for generating an event or a message;

means for holding contents of a certain number or a certain amount of events or messages; and

means for performing a batch notification of the contents of a certain number or a certain amount of events or messages as an interrupt, and for performing a process of preserving software execution environment directly before the interrupt occurs, a process in accordance with the contents of a certain number or a certain amount of events or messages and a process of recovering the software execution environment directly before the interrupt occurs.

The device according to the present invention holds the contents of a certain number or a certain amount of events or messages from a peripheral device, batch notifies a processing device of the contents of a certain number or a certain amount of events or messages as an interrupt, and performs a process of preserving software execution environment directly before the interrupt occurs, a process in accordance with the contents of a certain number or a certain amount of events or messages and a process of recovering the software execution environment directly before the interrupt occurs.

That is to say, the device according to the present invention performs at one time processes of preserving and recovering the software execution environment for a certain number or a certain amount of events or messages and performs a batch process in accordance with the contents of a certain number or a certain number of amount of events or messages instead of performing processes of preserving and recovering software execution environment at a number of times in accordance with the number or amount of events or messages.

As a result, it is possible to reduce the number of executions of processes of preserving and recovering the software execution environment directly before the interrupt occurs. Also, since holding of the contents of a certain number or a certain amount of the events or the messages is a simpler process in comparison with a number of processes of preserving and recovering the software execution environment directly before the occurrence of the interrupt corresponding to a certain number or a certain amount of events or messages, it is possible to reduce the overhead at the time of the interrupt handling furthermore in a computer in comparison with the prior art.

A batch interrupts handling method according to the present invention comprises steps of:

holding contents of a certain number or a certain amount of events or messages;

performing a batch notification of the contents of a certain number or a certain amount of events or messages as an interrupt;

preserving software execution environment directly before the interrupt occurs;

performing a process in accordance with the contents of a certain number or a certain amount of events or messages; and

recovering the software execution environment directly before the interrupt occurs.

According to the present invention, it is possible to perform an interrupt handling process with a less overhead in comparison with the prior art.

A batch interrupts handling program executed by a computer according to the present invention, comprises steps of:

holding contents of a certain number or a certain amount of events or messages;

performing a batch notification of said contents of a certain number or a certain amount of events or messages as an interrupt;

preserving software execution environment directly before said interrupt occurs;

performing a process in accordance with said contents of a certain number or a certain amount of events or messages; and

recovering said software execution environment directly before said interrupt occurs.

According to the present invention, it is possible to perform an interrupt handling process with a less overhead in comparison with the prior art.

A virtual shared memory according to the present invention comprises:

thread program extracting means for extracting a read side thread program and a write side thread program from a program for performing a read operation and a write operation; and

synchronization control means for performing a synchronization control between the read side thread program and the write side thread program for a write side thread and a read side thread executed on the same processor or on different processors from each other in accordance with the relation between the write side thread and the read side thread on the basis of the read operation and the write operation.

According to the present invention, since the memory extracts a read side thread program and a write side thread program from such a program for performing a read operation and a write operation as a user program and performs a synchronization control between the read side thread program and the write side thread program in accordance with the relation between a write side thread and a read side thread, it is possible to perform a read operation in a state where data have been already written.

As a result, it is hardly necessary to stand by for a write operation and the overhead is reduced. And since it is possible to properly control a write operation and/or a read operation in timing, the standby time and/or the number of standbys is remarkably reduced and an overhead is reduced.

Further, since it is possible to predict the synchronization between a write operation and a read operation by a language processing system properly, it is not necessary to design a program in consideration of the synchronization, and thus a burden to a user is reduced.

Preferably, the read operation and the write operation are handled as a read event and a write event, respectively. And the read thread program and the write thread program are respectively converted from existing program codes by a language processing system, and thereafter are formed into a read thread program and a write thread program having forms suitable for performing respectively a read operation and a write operation by means of the same processor or different processors from each other.

A virtual shared storing method according to the present invention comprises steps of:

extracting a read side thread program and a write side thread program from a program for performing a read operation and a write operation; and

performing a synchronization control between the read side thread program and the write side thread program for a write side thread and a read side thread executed on the same processor or on different processors from each other in accordance with the relation between the write side thread and the read side thread on the basis of the read operation and the write operation.

According to the present invention, it is possible to reduce an overhead when performing a virtual shared storage and reduce a burden to a user.

A virtual shared storing program executed by a computer according to the present invention comprises steps of:

extracting a read side thread program and a write side thread program from a program for performing a read operation and a write operation, and performing a synchronization control between the read side thread program and the write side thread program for a write side thread and a read side thread executed on the same processor or on different processors from each other in accordance with the relation between the write side thread and the read side thread on the basis of the read operation and the write operation.

According to the present invention, it is possible to reduce an overhead when performing a virtual shared storage by means of a computer and reduce a burden to a user.

A multiple concurrent processing device according to the present invention comprises:

means for dividing an existing program into a plurality of thread programs by means of a language processing system;

means for holding an interrupt from outside during execution of the thread program; and

means for executing the interrupt after thread program has been ended.

According to the present invention, since it divides an existing program into a plurality of thread programs by means of a language processing system and executes an interrupt from outside after the thread program has been ended, it is not necessary to suspend the program for each interrupt. In such a way, by executing thread by thread a program divided into a plurality of thread programs through taking a thread as a unit, it is possible to reduce an overhead at the time of changing over a program execution environment between execution and interrupt of the program. Even if a plurality of interrupts from outside have occurred, since the present invention can perform a plurality of interrupts in batch after a thread has been ended, it remarkably reduces the number of changeover operations of a program execution environment between execution and interrupt of a program, and thus it is not necessary to make complicated the configuration of computers and the composition of basic software for changeover of a program execution environment between the execution and the interrupt of the program, and there is not the possibility that the burden to a user's program description is remarkably increased.

A multiple concurrent processing method according to the present invention comprises steps of:

dividing an existing program into a plurality of thread programs by means of a language processing system,

holding an interrupt from outside during execution of the thread program; and

executing the interrupt after the thread program has been ended.

According to the present invention, it is possible to reduce an overhead at the time of changeover of a program execution environment between execution and interrupt of a program without making complicated the configuration of computers and the composition of basic software, and without remarkably increasing the burden to a user's program description.

A multiple concurrent processing program executed by a computer according to the present invention comprises steps of:

dividing an existing program into a plurality of thread programs by means of a language processing system;

holding an interrupt from outside during execution of the thread program; and

executing the interrupt after the thread program has been ended.

According to the present invention, it is possible to execute by means of a computer program a multiple concurrent process which reduces an overhead at the time of changeover of a program execution environment between the execution and the interrupt of a program without making complicated the configuration of computers and the composition of basic software, and without remarkably increasing the burden to a user's program description.

### BRIEF DESCRIPTION OF DRAWINGS

FIG. 1 is a diagram showing a computer having a batch interrupts handling device according to the present invention.

FIG. 2 is a flowchart of operation of a batch interrupts handling device according to the present invention.

FIG. 3 is a diagram showing a computer performing a batch interrupts handling method according to the present invention.

FIG. 4 is a diagram showing software inside an arithmetic unit.

FIG. 5 is a program block diagram showing the structure of a thread program describing write and read operations to and from a virtual shared memory in a first and a second embodiment of the virtual shared memory.

FIG. 6 is a program block diagram showing the structure of a thread program including write and read operations to and from a distributed memory executed in a first and a second embodiment of the virtual shared memory.

FIG. 7 is a hardware block diagram showing a mechanism for data transmission and thread synchronization control between distributed memories.

FIG. 8 is a diagram showing in detail a data transfer device and an arithmetic unit in FIG. 7.

FIG. 9 is a hardware block diagram of a second embodiment of the present invention of the virtual shared memory.

FIG. 10 is a diagram showing an operation flow of software for data transmission/reception and thread execution management with regard to writing and reading data in FIG. 8.

FIG. 11 is a program block diagram showing the structure of a thread program executed in the present invention.

FIG. 12 is a block diagram showing the whole composition of a multiple concurrent processing device according to the present invention.

FIG. 13 is a block diagram of hardware for performing a multiple concurrent processing method according to the present invention.

FIG. 14 is a diagram showing an operation process of software inside an external device, a storage device and an arithmetic unit of FIG. 13.

### BEST MODE FOR CARRYING OUT THE INVENTION

Firstly, embodiments of a batch interrupts handling device and method, and a batch interrupts handling program executed by a computer according to the present invention are described in detail with reference to the drawings.

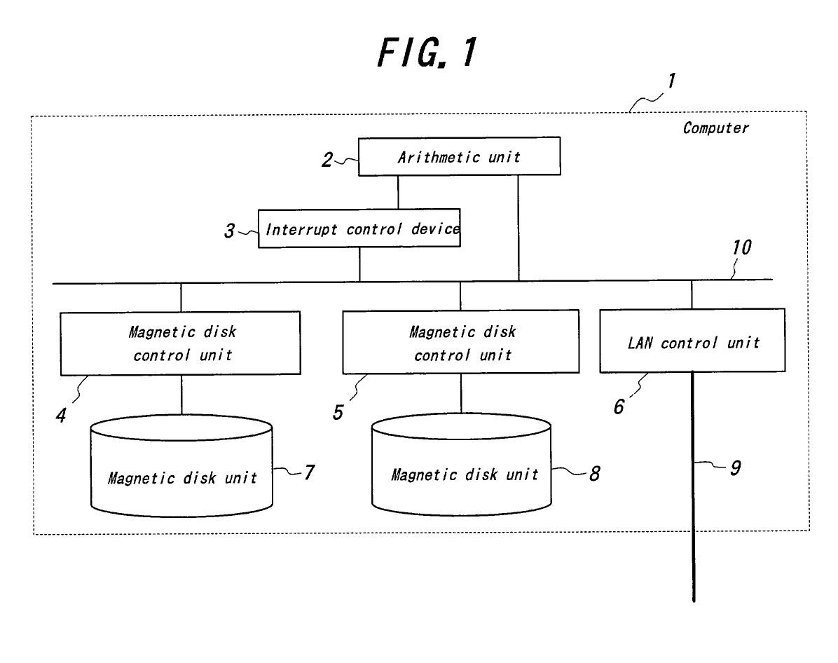

FIG. 1 is a diagram showing a computer having a batch interrupts handling device according to the present invention.

A computer 1 comprises an arithmetic unit 2 and an interrupt control device 3, magnetic disk units 4, 5 and a LAN control unit 6 as peripheral units to generate an event or a message, magnetic disk units 7 and 8 controlled by the magnetic disk control units 4 and 5, a LAN communication path 9 connected to the LAN control unit 6, and a bus 10 for performing data transmission among the arithmetic unit 2, the interrupt control device 3, the magnetic disk control units 4 and 5, and the LAN control unit 6.

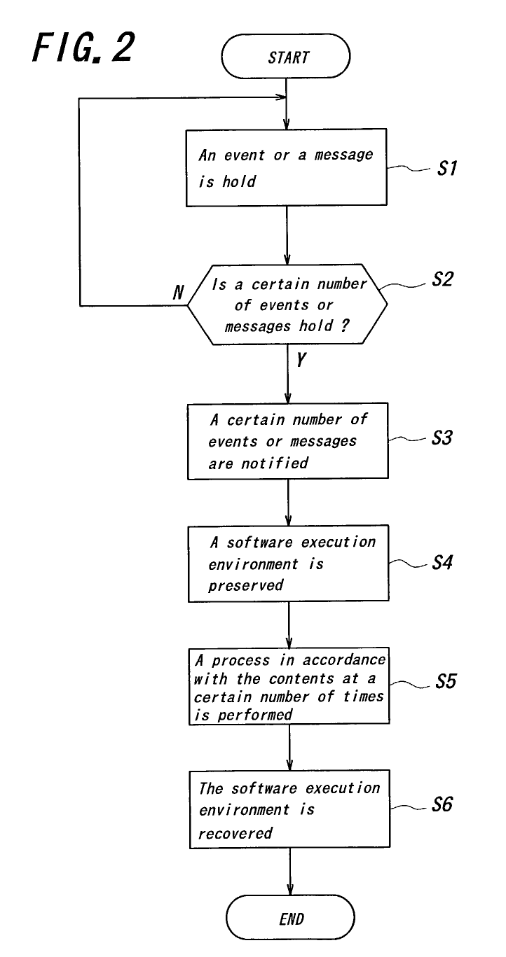

FIG. 2 is a flowchart of operation of a batch interrupts handling device according to the present invention. Steps S1 to S3 described later in this routine are implemented inside the interrupt control device 3, and steps S4 to S6 are implemented as software inside the arithmetic unit 2.

First, in step S1 the interrupt control device 3 is notified of contents of an event or a message generated in the magnetic disk control unit 4 or 5, or the LAN control unit 6, and the interrupt control device 3 holds the contents of an event or a message. Next, in step S2 the interrupt control unit 3 judges whether or not it has held a certain number (e.g. 3) of events or messages. In case of holding a certain number of events or messages, the interrupt control device 3 batch-notifies the arithmetic unit 2 of a certain number of held events or messages (step S3). On the other hand, in case that a certain number of events or messages are not held, this routine returns to step S1.

When the arithmetic unit 2 is batch-notified of the contents of a certain number of events or messages, the arithmetic unit 2 preserves software execution environment directly before the interrupt occurs (step S4), performs a process in accordance with the contents of a certain number of events or messages (step S5), recovers the software execution environment directly before the interrupt occurs (step S6), and ends this routine.

According to the embodiment, by implementing a mechanism for batch-notifying the arithmetic unit 2 of the contents of the interrupts, the number of executions of processes of preserving and recovering the software execution environment directly before the occurrence of interrupt is reduced, and a certain number of processes of holding the contents of the specified number of events or messages are performed, each processes being simpler in comparison with a process of preserving or recovering the software execution environment directly before the interrupt occurs, so that it is possible to reduce the overhead furthermore at the time of interrupt handling in a computer in comparison with the prior art.

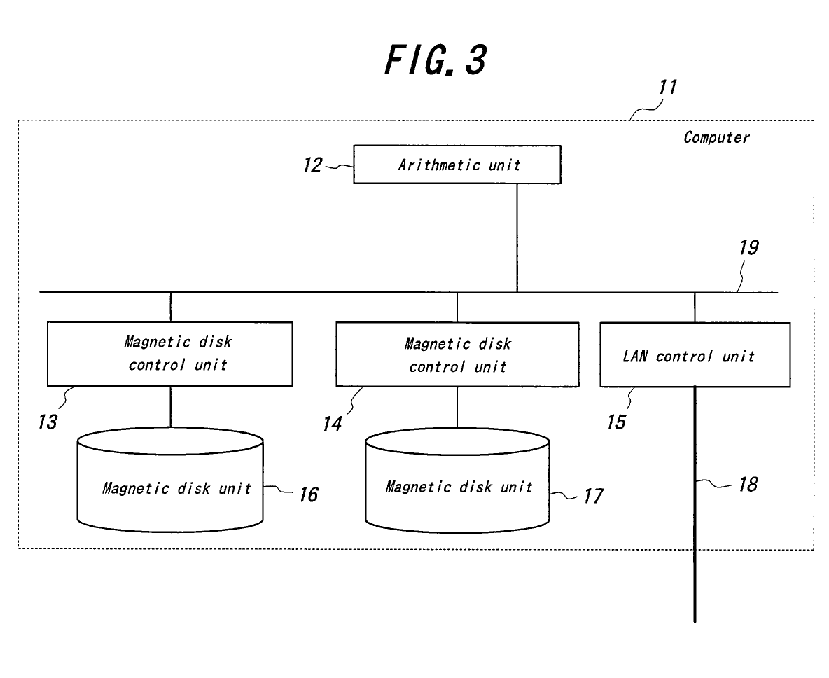

FIG. 3 is a diagram showing a computer performing a batch interrupts handling method according to the present invention.

A computer 11 comprises an arithmetic unit 12, magnetic disk units 13, 14 and a LAN control unit 15 as peripheral units to generate an event or a message, magnetic disk units 16 and 17 controlled by the magnetic disk control units 13 and 14, a LAN communication path 18 connected to the LAN control unit 15, and a bus 19 for performing data transmission among the arithmetic unit 12, the magnetic disk control units 13 and 14, and the LAN control unit 15.

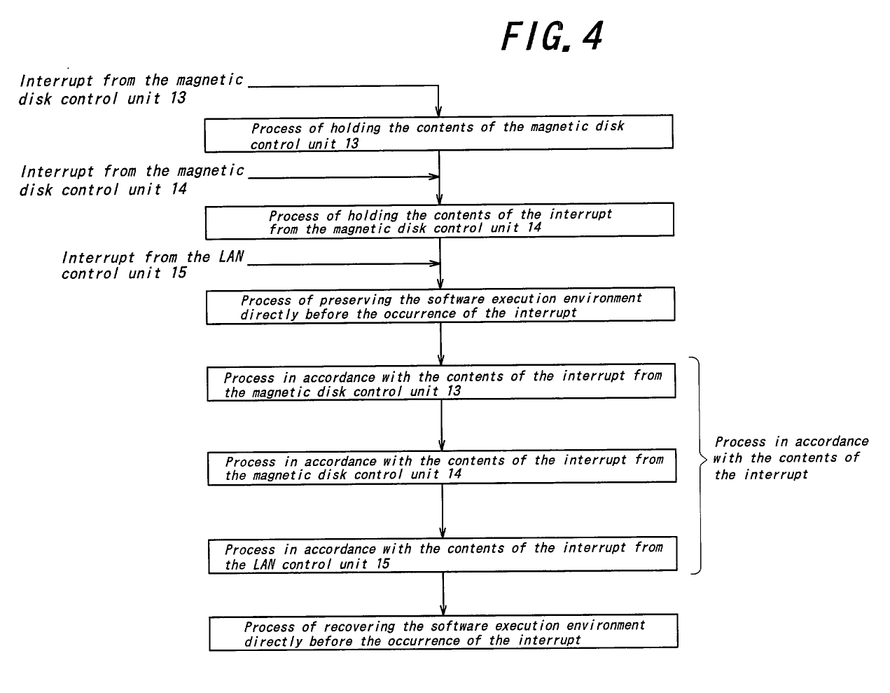

FIG. 4 is a diagram showing the software inside the arithmetic unit. In this case, first the arithmetic unit 12 is notified of an event or a message, namely, an interrupt from the magnetic disk control unit 13.

The arithmetic unit 12 holds the contents of the notified event or message. In this case, it performs a simple process of only holding the contents but does not perform processes of preserving and recovering the software execution environment directly before the interrupt occurs.

Next, the arithmetic unit 12 is notified of an event or message, namely, an interrupt from the magnetic disk control unit 14. The arithmetic unit 12 holds the contents of the notified event or message. In this case also, it performs a simple process of only holding the contents but does not perform processes of preserving and recovering the software execution environment directly before the interrupt occurs.

Next, the arithmetic unit 12 is notified of an event or message, namely, an interrupt from the LAN control unit 15. On the basis of the notification of the event or message from the LAN control unit 15, the arithmetic unit 12 preserves the software execution environment directly before the interrupt occurs, performs a process in accordance with the contents of the event or message from the magnetic disk control units 13, 14 and the LAN control unit 15, and recovers the software execution environment directly before the interrupt occurs. The number of processes performed correspondingly to the contents of events or messages is equal to the number of the contents.

According to the embodiment, by implementing a mechanism for batch-notifying the arithmetic unit 2 of the contents of the interrupt, the number of executions of processes of preserving and recovering the software execution environment directly before the occurrence of the interrupt is reduced, and a certain number of processes of holding the contents of a certain number of events or messages are performed, each processes being simpler in comparison with a process of preserving or recovering the software execution environment directly before the occurrence of the interrupt, so that it is possible to reduce the overhead furthermore at the time of the interrupt handling in a computer in comparison with the prior art.

Secondary, Embodiments of a virtual shared memory, a virtual shared storing method and a virtual shared storing program executed by a computer according to the present invention are described in detail with reference to the drawings.

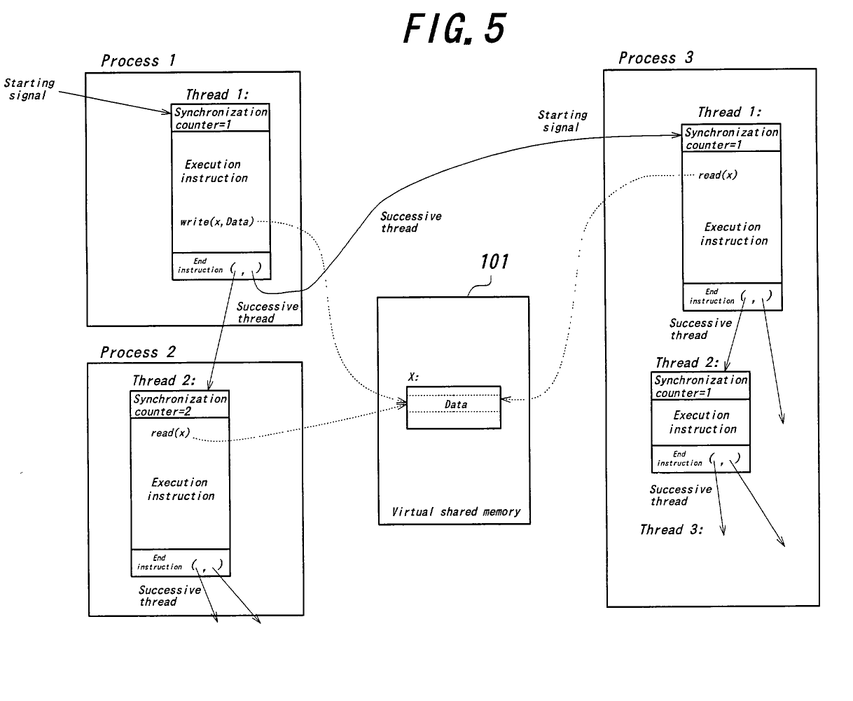

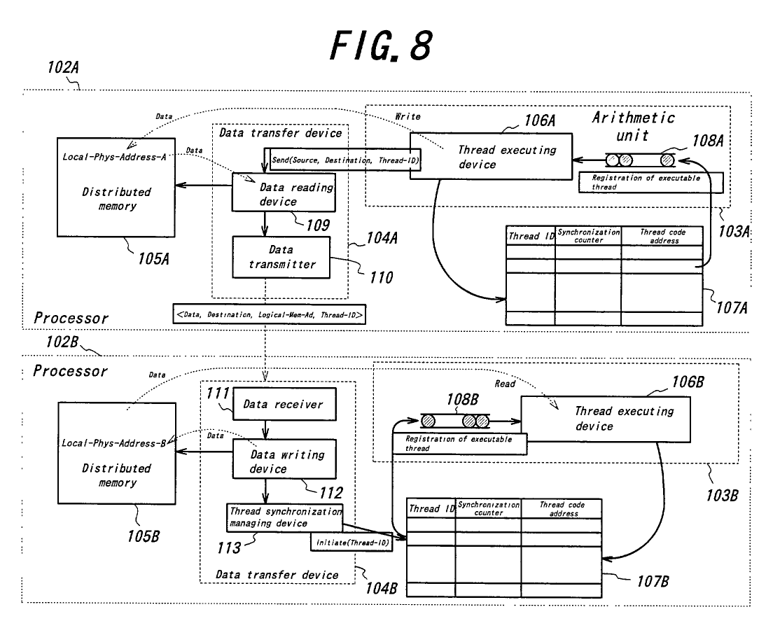

A first embodiment described using FIGS. 5 to 8 implements by means of hardware a mechanism performing a write operation and a read operation to and from shared distributed memories in the same processor or different processors from each other, and describes each of a read operation and a write operation from and to a virtual shared memory as a thread program as shown in FIG. 5. Such a thread program has been converted from an existing program code by a language processing system.

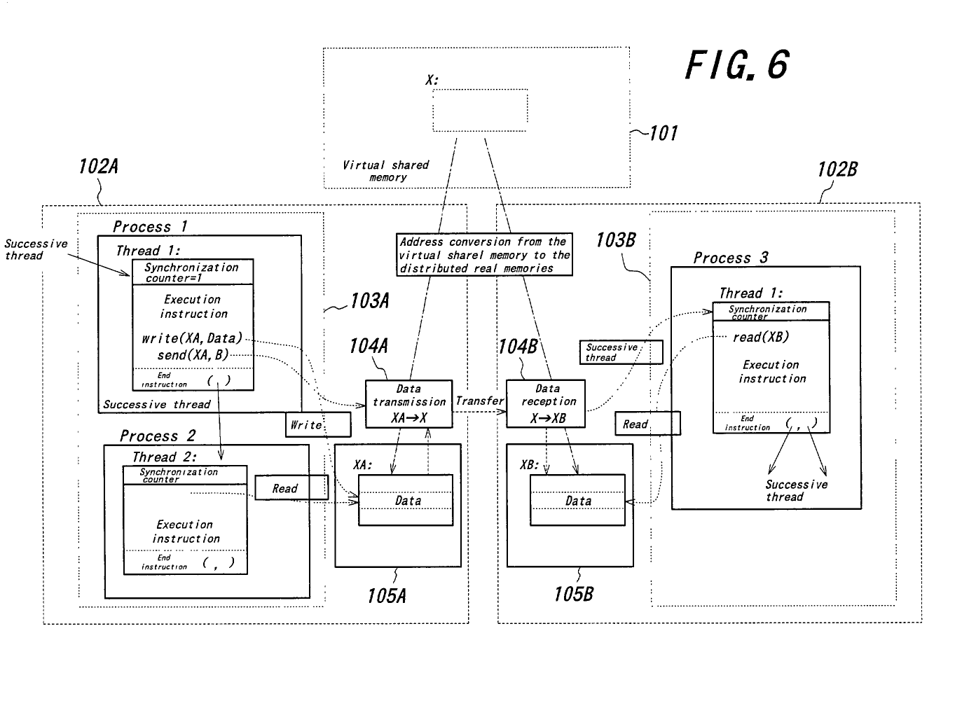

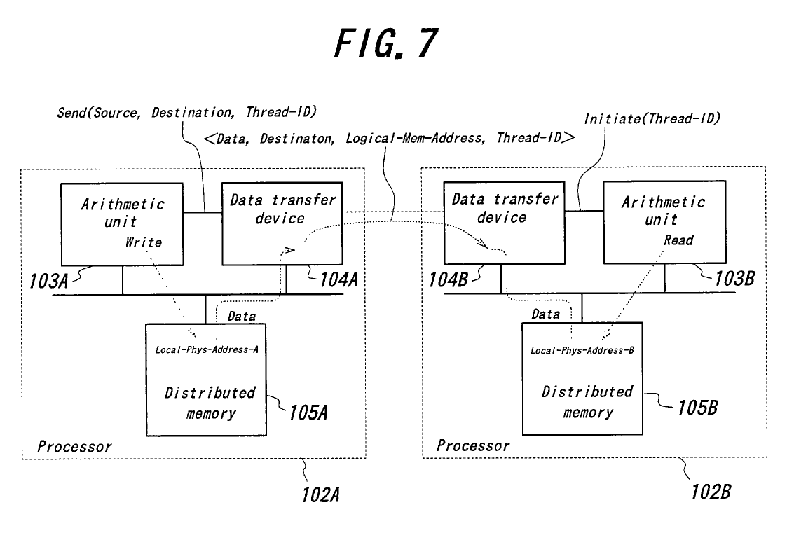

Further, a program shown in FIG. 15 is automatically converted into thread programs performing a write operation and a read operation to and from distributed real memories as shown in FIG. 7 by means of a program loader at the time of program activation including the time of process activation. A program shown in FIG. 6 is executed by a hardware device as shown in FIG. 7.

A virtual shared memory 101 extracts a read side thread program and a write side thread program from a program for performing a read operation and a write operation, and performs a synchronization control between the read side thread program and the write side thread program for a write side thread and a read side thread executed on the same processor or different processors 102A and 102B from each other in accordance with the relation, for example, the relation of interdependence between a write side thread and a read side thread on the basis of a read operation and a write operation, as described later.

Processors 102A and 102B have respectively arithmetic units 103A and 103B, data transfer devices 104A and 104B, and distributed memories 105A and 105B. A write side thread program is loaded into processor 102A and has been already loaded into processor 102B at the time of loading a program or starting a process prior to execution (see FIG. 6). At the same time as this, conversion tables between a virtual shared memory 101 and the distributed memories 105A and 105B to be written to and read from are produced in the transfer devices 104A and 104B, respectively.

The write side thread program is executed by a thread executing device 106A of the arithmetic unit 103A. When a write instruction is executed during execution of the program, data are written into the distributed memory 105A.

Hereupon, a case that a read side thread is executed by the same processor, namely, the processor 102A is described.

When the write side thread program executes a thread execution end instruction, it issues a starting signal to a read side thread specified as the successive thread, namely, to thread 102 of process 102 shown in FIGS. 5 and 6. This operation registers the read side thread at a synchronization standby thread management table 107A and decreases a synchronization counter of the read side thread by 1 at the same time as the registration.

The read side thread which has received the starting signal, namely, the thread 102 of the process 102 shown in FIGS. 5 and 6 is managed in the synchronization standby management table 107A, and is put into an execution standby thread queue 108A when a starting synchronization condition has been completed by a fact that all starting signals by other events have arrived and the synchronization counter of the synchronization standby management table 107A becomes zero. At the same time, this thread is deleted from the synchronization standby management table 107A. Thereafter, this thread is taken out from the synchronization standby thread queue 108A and is executed by the thread executing device 106A. The thread executing device 106A reads data (Data) from an address in the distributed memory 105A (Local-Phys-Address-A: XA in FIG. 6) at the time of executing a read instruction (read) when the thread is being executed.

Next, a case that a read side thread is executed by another processor, namely, processor 102B is described.

A write side thread program executes a data send instruction (send) after a write operation has been ended. According to the data send instruction, it transmits an address in the distributed memory 105A holding data to be transferred (Local-Phys-Address-A: XA in FIG. 6), the name of a destination processor (Destination: processor 102B in this case) and the name of a read side thread to be activated (Thread-ID) to the data transfer device 104A. The Thread-ID has a processor name and a process name also contained in it, and thread 101 of process 103 corresponds to this in FIGS. 5 and 6.

The data transfer device 104A reads data (Data) obtained from the distributed memory 105A by the data reading device 109 from an address in the distributed memory 105A (Local-Phys-Address-A: XA in FIG. 6), and transfers the data by means of the data transmitter 110 to a destination processor (Destination: processor 102B in this case).

At this time, the data transfer device 104A performs an address conversion from an address in the distributed memory 105A (Local-Phys-Address-A: XA in FIG. 6) to an address in the virtual shared memory 101 (Logical-Mem-Address: X in FIG. 6), and transmits together with data (Data) an address in the virtual shared memory 101 (Logical-Mem-Address: X in FIG. 6) and the name of a read thread to be activated (Thread-ID) by means of the data transmitter 110.

When the data transfer device 104B receives the transferred data (Data), the address in the virtual shared memory 101 (Logical-Mem-Address: X in FIG. 6) and the name of a read thread to be activated (Thread-ID) by means of the data receiver 111, the data transfer device 104B performs an address conversion from the address in the virtual shared memory 101 (Logical-Mem-Address: X in FIG. 6) to the address (Local-Phys-Address-B) in the distributed memory 105B, and writes the transferred data into the address in the distributed memory 105B (Local-Phys-Address-B).

When the write operation has been ended, a starting signal is issued. This operation activates the thread synchronization managing device 113 and decreases by 1 the synchronization counter of the read side thread specified by the Thread-ID in the synchronization standby thread management table 107B.

The read side thread which has received a starting signal, namely, the thread 1 of the process 103 is managed in the synchronization standby management table 107B, and is put into an execution standby thread queue 108B when a starting synchronization condition has been completed by a fact that all starting signals by other events have arrived and the synchronization counter of the synchronization standby management table 107B becomes zero. At the same time, this thread is deleted from the synchronization standby management table 107B. Thereafter, this thread is taken out from the execution standby thread queue 108B and is executed by the thread executing device 106B. The thread executing device 106B reads data (Data) from an address in the distributed memory 105B (Local-Phys-Address-B: XB in FIG. 6) at the time of executing a read instruction (read) when the thread is being executed.

Next, a second embodiment is described with reference to FIGS. 5, 6, 9 and 10.

The second embodiment has implemented by means of software a mechanism performing a write/read execution, another event processing and a thread execution (internal operation process) as a concurrent operation.

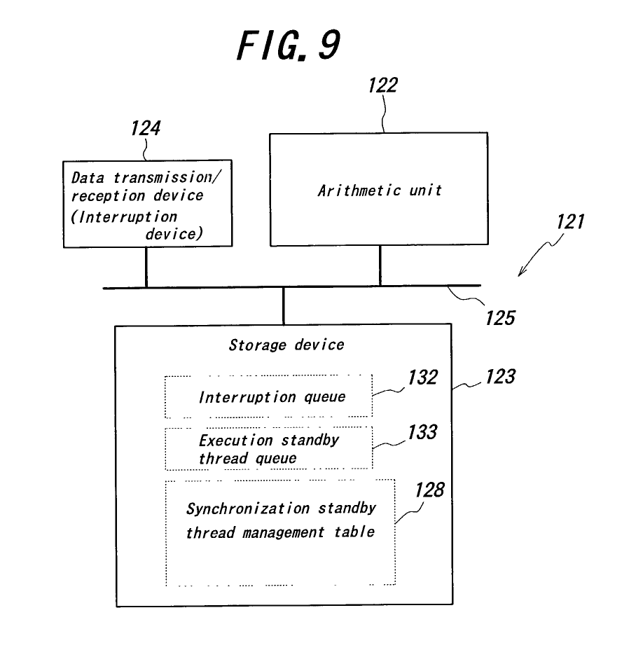

This embodiments also assumes that a read thread program and a write thread program in FIG. 6 loaded prior to execution are executed. And it is assumed that the software described above is used in a hardware device 121 on the market as shown in FIG. 9, and this hardware device 121 comprises an arithmetic unit 122, a memory device 123, a data transmitter/receiver device (interrupt device) 124 and a bus 125 for transferring data among these devices.

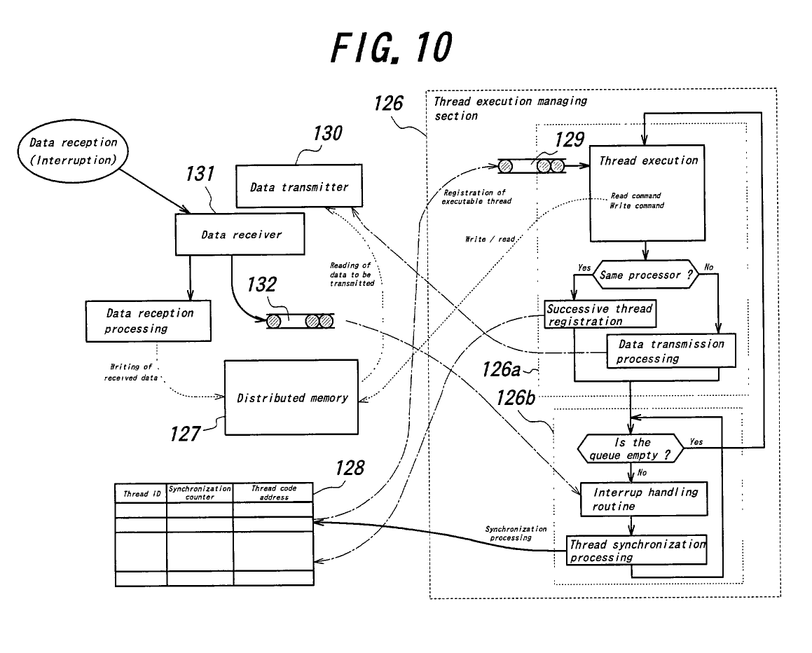

The operation of this embodiment is described mainly with reference to FIG. 10.

As described in the first embodiment, a thread execution managing section 126 runs in the arithmetic unit 122 executing a write side thread. At the same time as this, when it receives data transferred from another processor, it handles the data in the same way as other events externally generated.

When a write instruction (write) is executed during execution of a write side thread program, data (Data) are written into an address in a distributed memory 127 (Local-Phys-Address-A: XA in FIG. 6) specified by an operand of the write instruction.

When the execution of this thread is ended by the execution of a thread execution end instruction, a read side thread specified by an operand of the thread execution end instruction is registered as the successive thread.

Hereupon, a case that a read side thread is executed in the same processor.

In a successive thread registration, the read side thread is registered at a synchronization standby thread management table 128, and at the same time as this, the synchronization counter in the synchronization standby thread management table 128 of this read side thread is decreased by 1.

When a starting synchronization condition has been completed by a fact that all starting signals by other events have arrived and the synchronization counter becomes zero, the read side thread is put into an execution standby thread queue 129. At the same time, this thread is deleted from the synchronization standby management table. Thereafter, when this thread is taken out from the execution standby thread queue, the execution is started. When a read instruction (read) has been executed during execution of this thread, the thread executing device accesses an address in the distributed memory 127 (Local-Phys-Address-A: XA in FIG. 6).

Next, a case that a read side thread is executed in another processor is described.

The data transmission processing section of the thread execution managing section 126 performs an address conversion into an address in a virtual shared memory (Local-Mem-Address: X in FIG. 6), and transfers data by driving a data transfer device (not shown).

At this time, the data processing section of the thread execution managing section 26 transmits an address in the distributed memory 127 (Local-Phys-Address-A: XA in FIG. 6) holding data to be transferred, the name of a destination processor (Destination: processor 102 in FIG. 6) and the name of a read side thread to be activated (Thread-ID) to a data transmitter 130. The name of a thread includes the name of a processor and the name of a process in which its successive thread is executed, and corresponds to thread 101 in process 103 executed by processor 102B in FIG. 6.

The data transmitter 130 reads the written data (Data) from an address in the distributed memory 127 (Local-Phys-Address-A: XA in FIG. 6) and transmits the data to a destination processor (processor 102 in FIG. 6). At this time the data transmitter 130 transfers together with the data an address in the virtual shared memory (Local-Mem-Address: X in FIG. 6) and the name of a read side thread to be activated (Thread-ID).

When the destination processor receives the data, an event related to the data is taken by a data receiver 131 and is held in an interrupt queue 132. At this time the data receiver 131 obtains an address in the distributed memory of the destination processor (Local-Phys-Ad-B: XB in FIG. 6) from an address in the virtual shared memory (Local-Mem-Address: X in FIG. 6), and writes the transferred data (Data) into the address in the distributed memory (Local-Phys-Ad-B: XB in FIG. 6).

When this write operation has ended, the event is put into the interrupt queue 132.

In the arithmetic unit 122, the thread execution managing section 126 operates. The thread execution managing section 126 has a thread executing section 126a and an interrupt handling execution section 126b. The thread executing section 126a takes and executes an execution standby thread kept in an execution standby thread queue 133 from the head of the queue. The thread executed (read thread) accesses an address in the distributed memory (Local-PhysAd-B: XB in FIG. 6) for reading, when it executes a read instruction in the thread.

Management of execution of threads including a write side thread and a read side thread is performed in the following.

1. When one thread execution is ended, control is passed to the interrupt handling execution section 126b. The interrupt handling execution section 126b repeats the following operations until the interrupt queue 132 is made empty.

2. It takes an interrupt from the head of the interrupt queue, examines its interrupt cause and executes its corresponding interrupt handling routine.

3. In relation to a thread standing by for the event out of threads registered at the synchronization standby thread management table 128, its synchronization counter is decreased by 1 (thread synchronization process).

4. In case that the value of the synchronization counter is made zero as the result, the interrupt handling execution section 126b deletes the thread from the synchronization standby thread management table 128 and puts it into the execution standby queue.

5. When the interrupt handling execution section 126b ends its processing, control is passed to the thread executing section 126a.

According to the above-mentioned embodiment, an overhead and a burden to a user are reduced by making a program including a write and a read operation to and from a virtual shared memory into thread programs, and by controlling the synchronization between a write side thread and a read side thread by means of a synchronization signal.

A user program describes a write operation and a read operation in no consideration of synchronization between a write operation and a read operation on a virtual shared memory, and its language processing system analyzes the relation of interdependence between a write operation and a read operation with regard to its memory resource, extracts automatically sections requiring a synchronization control, divides the program into a program piece including a write operation and a program piece including a read operation, and makes each of them into a thread.

When a program is executed, a virtual shared memory space is mapped to distributed memory spaces distributed to the respective processors, and a write operation and a read operation each are performed on a distributed memory in a processor in which a thread including one of the respective operations is executed.

For a write side thread, the program performs a write operation to a distributed memory existing at the write side, and after the write operation has ended, it transmits a write end notification to a read side thread. In case that a read side thread is executed in the same processor as the write side thread, when receiving a write end notification the read side thread is activated and performs a read operation from a distributed memory on that processor.

On the other hand, in case that a read side thread is executed on another processor, a data transfer device is operated by a write end notification and transfers data from the distributed memory at the write side to the distributed memory at the read side, and at the same time, it transmits the name of the read side thread to the read side processor. A data transfer device at the read side writes the data into the distributed memory, and thereafter transmits a write end notification to the read side thread and activates the read side thread.

Therefore, this embodiment divides a program performing a write operation and a read operation to and from a virtual shared memory into a write side thread program and a read side thread program, handles each of a write operation and a read operation as an event, and performs a synchronization control between a write side thread and a read side thread executed on the same processor or different processors from each other in accordance with the relation of interdependence between the threads on the basis of the relation of order between a write event and a read event.

As a result, a write operation and a read operation can be performed at proper timing, and the following effects can be obtained.

1. A memory lock operation and a memory unlock operation at the time of a write operation and a read operation are made unnecessary.

2. Management for keeping the consistency of data between distributed memories is simplified.

3. The standby time and/or the number of standbys for a write operation and a read operation can be remarkably reduced, and a process state control for a write operation and a read operation can be simplified.

4. Since a user program can briefly describe a read operation and a write operation from and to a shared memory in no consideration of timing of a write operation and a read operation among distributed memories, design of a program is made easy.

Thereby, it is possible to simplify a distributed shared memory management mechanism and simplify the configuration of concurrent distributed computers and the design of a concurrent distributed operating system.

Finally, embodiments of a multiple concurrent processing device, a multiple concurrent processing method, and a multiple concurrent processing program executed by a computer according to the present invention are described in detail with reference to the drawings.

First, a first embodiment is described.

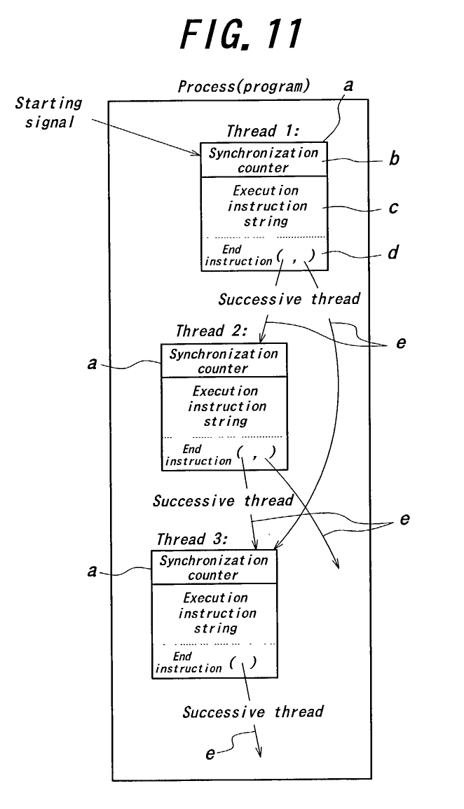

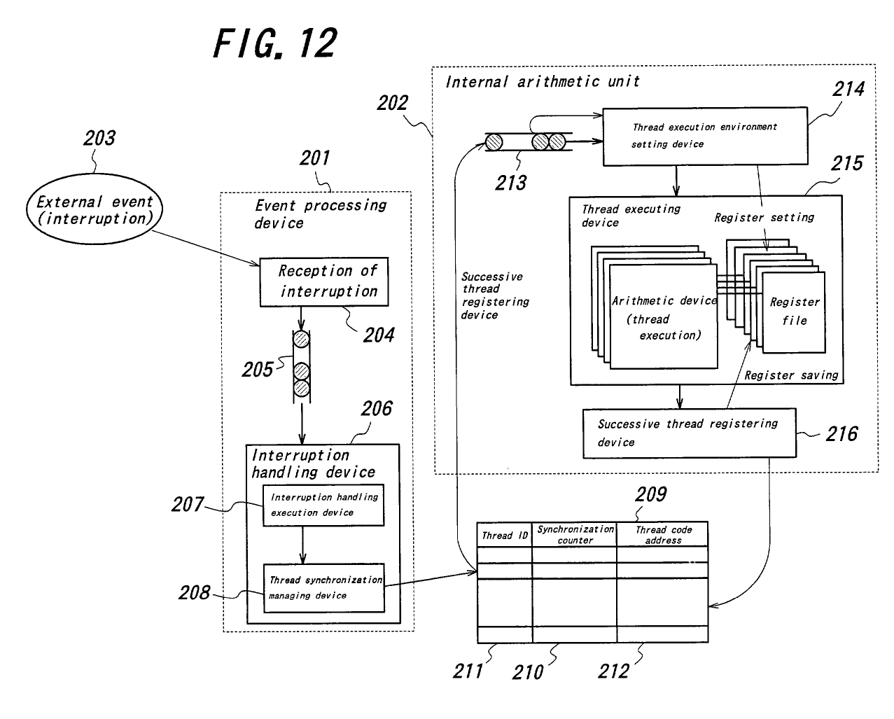

The first embodiment implements by means of hardware a mechanism to perform an event process and a thread execution (internal arithmetic operation process) independently of each other and concurrently. In this embodiment, on the assumption that it executes a program code obtained by converting an existing program code into a thread program structure as shown in FIG. 11 by means of a language processing system, a process is performed by an event processing device 201 and an internal arithmetic unit 202 of FIG. 12 which form a multiple concurrent processing device according to the present invention.

In FIG. 11, symbols a, b, c, d and e represent a thread code, a thread starting condition (synchronization counter), a thread execution instruction string, a thread execution end instruction and a successive thread information (pointer), respectively.

The event processing device 201 and the internal arithmetic unit 202 operate concurrently. The event processing device 201 processes an external event (interrupt) 203 and performs a thread synchronization management, and the internal arithmetic unit 202 performs exclusively execution of an executable thread.

In this situation, when an external event 203 occurs, it is taken up by an interrupt receiving device 204 of the event processing device 201 and is held in an interrupt queue 205 of the event processing device 201.

An interrupt handling device 206 of the event processing device 201 takes out one by one the interrupts held in the interrupt queue 205 and performs an interrupt handling operation. The interrupt handling device 206 has an interrupt handling execution device 207 and a thread synchronization managing device 208, and performs the following operations.

1. It executes a corresponding interrupt handling routine on the basis of an interrupt cause.

2. The thread synchronization managing device 208 decreases by 1 a synchronization counter 210 of a thread standing by for an event caused by the interrupt according to the result of interrupt handling with regard to synchronization standby threads held in a synchronization standby thread management table 209. A thread standing by for an event caused by interrupt is identified by means of its thread ID 211.

3. As a result of decreasing by 1 the synchronization counter 210, when its value becomes zero, the interrupt handling device 206 puts the thread ID 211 and the thread code address 212 of the corresponding thread into an execution standby queue 213 in the internal arithmetic unit 202.

The internal arithmetic unit 202 takes up and executes an executable thread being held in the execution standby thread queue 213. The internal arithmetic unit 202 further comprises a thread execution environment setting device 214, a thread executing device 215 and a successive thread registering device 216, and performs the following process.

1. The thread execution environment setting device 214 assigns a free register file in advance to an execution standby thread whose turn of execution has become near, namely, which has moved near the forefront of the queue, and sets an execution environment of the corresponding thread in the register file (recovery of an execution environment).

2. The internal arithmetic unit 202 takes out a thread executed from the forefront of the execution standby queue 213, and makes a currently free arithmetic device start a thread execution by means of the already assigned register file. The thread execution performs exclusively an instruction string until execution of a thread execution end instruction without stopping halfway.

3. The successive thread registering device 16 executes a thread execution end instruction. Since a thread execution end instruction has as its operand the name (the thread ID and its code address) of a thread executed successively to the current thread (successive thread) and the initial value of its synchronization counter, the successive thread registering device 216 registers the successive thread at the synchronization standby thread management table 209 by means of the operand information. In case that the same successive thread exists already in the synchronization standby thread management table 209, the synchronization counter 210 is decreased by 1.

4. As a result of decreasing by 1 the synchronization counter 210, when its value becomes zero and a starting condition is completed, the device 216 puts the thread ID and the code address of the current thread into the execution standby queue 213 of the internal arithmetic unit 202.

Next, a second embodiment is described.

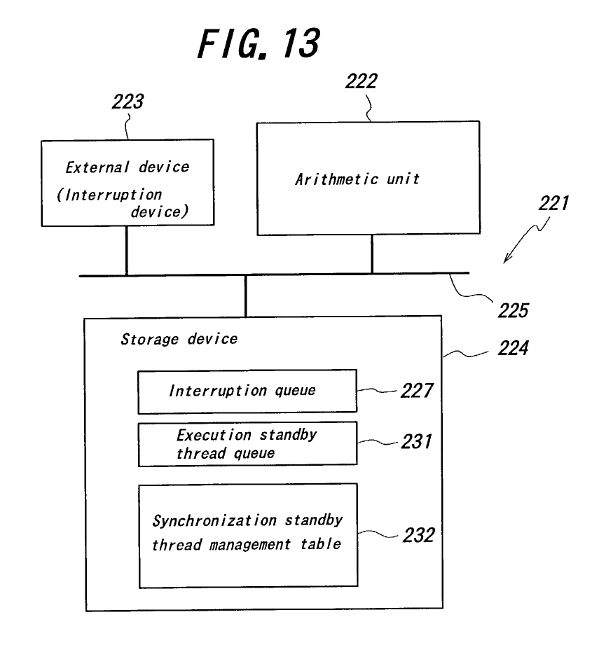

The second embodiment implements by means of software a mechanism to perform an event process and a thread execution (internal arithmetic operation process) independently of each other and concurrently. In this embodiment also, on the assumption that it executes a program code obtained by converting an existing program code into a thread program structure as shown in FIG. 11 by means of a language processing system, a process is performed by a hardware device 221 on the market as shown in FIG. 13, said hardware device 221 performing a multiple concurrent processing method according to the present invention.

The hardware device 221 has an arithmetic unit 222, an external device (interrupt device) 223, a storage device 224 and a bus 225 for communicating data among them.

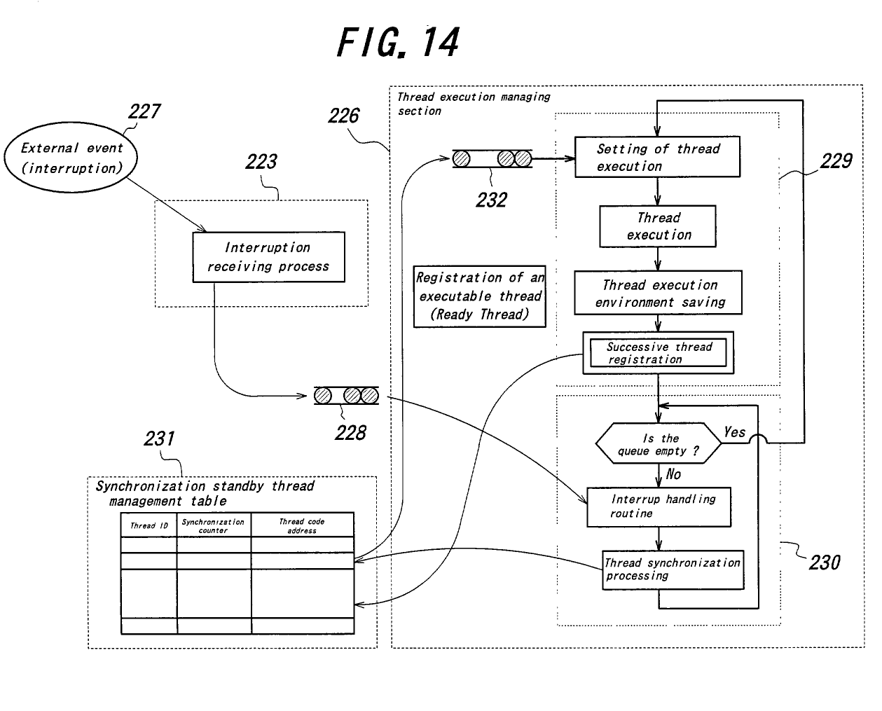

Operation of the embodiment is described with reference to FIG. 14 also.

At the same time as when a thread execution managing section 226 is operated in the arithmetic unit 222, an external event 227 is taken up by the external device 223 and is held in an interrupt queue 227 in the storage device 224. The thread execution managing section 226 has a thread executing device 229 and an interrupt handling execution section 230. Hereupon, an execution environment of a thread means the contents of a register.

When a thread execution end instruction is executed during execution of a thread, the execution of the thread is ended and the thread execution environment is saved by a thread execution environment saving section. In a thread execution end instruction, information of at least one thread being successive to the current thread is shown as an operand, and this successive thread is registered at a synchronization standby thread management table 231 of the storage device 224. In case that the same successive thread exists already in the synchronization standby thread management table 231, the synchronization counter is decreased by 1.

The thread executing section 229 takes out an execution standby thread held in an execution standby thread queue 232 from the forefront of the queue, sets an execution environment of this thread by means of a thread execution environment setting section, and executes a thread code (execution instruction string) in the thread executing section 229.

When one thread execution is ended, control is passed to the interrupt executing section 230. The interrupt executing section 230 repeats the following operations until the interrupt thread queue 228 is made empty.

1. It takes out an interrupt from the forefront of the interrupt queue 228, examines its interrupt cause, and executes a corresponding interrupt handling routine.

2. It decreases the synchronization counter by 1 for a thread standing by for the event, namely, a thread registered at a synchronization standby thread management table 232 (thread synchronization process).

3. As the result, in case that the value of the synchronization counter has become zero, the thread is deleted from the synchronization standby thread management table 231 and is put into the execution standby thread queue 232.

When the process of the interrupt executing section 230 is ended, control is passed to the thread executing section 229.

According to the embodiment, by analyzing the characteristics of an event process and an internal arithmetic operation process, a general program including concurrent and distributed processes is converted into a program comprising a plurality of threads by dividing said general program into a plurality of program pieces through taking as a unit a section (thread) capable of being devoted exclusively to an internal arithmetic operation process without being influenced by an external event, setting as a boundary a point at which execution is suspended by the influence of an external event. The division into threads can be automatically performed by a language processing system.

A thread is activated as controlling synchronization by arrival of the corresponding event, and the activated thread is executed without being influenced by an external event. Since a spot to be influenced by an external event has been identified in advance as an end of a thread, an event process can be collectively performed by computer hardware or basic software independently of a user program, and the user program can be devoted exclusively to an internal arithmetic operation process as a thread execution. Due to this, it is possible to hide an event process frequently generated in a concurrent and distributed process from a user program and more reduce an overhead in comparison with the prior art.

According to the embodiment, therefore, since interrupt handling operations can be performed in batch after execution of a thread, an external event interrupt does not influence on an internal arithmetic operation process. Thereby, it is possible to remarkably reduce the number of changeover operations of a program execution environment between execution of a user program and an interrupt processing routine, and more reduce the overhead of processing in comparison with the prior art.

And since a user program can exclusively execute an internal arithmetic operation process as a thread execution, it is possible to form the description of a synchronization process associated with an external event as a program based on the relation of interdependence of execution between threads each having an event as an opportunity. Due to this, a user program does not need to consider a synchronization control between events and it is made easy to design and develop a concurrent and distributed processing program.

The present invention is not limited the above embodiments but can be modified and varied in various manners.

For example, in the batch interrupts handling device, it is possible to use as a peripheral device any other device than a magnetic disk control unit or a LAN control unit. And a case of processing a certain number of events or messages collectively as interrupt has been described, but the present invention can be also applied to a case of processing a specified amount of events or messages collectively as interrupt.

1. A batch interrupts handling device comprising:
means for generating an event or a message;
means for holding contents of a certain number or a certain amount of events or messages; and
means for performing a batch notification of said contents of a certain number or a certain amount of events or messages as an interrupt, and for performing a process of preserving software execution environment directly before said interrupt occurs, a process in accordance with said contents of a certain number or a certain amount of events or messages and a process of recovering said software execution environment directly before said interrupt occurs.

2. A batch interrupts handling method comprising steps of:
holding contents of a certain number or a certain amount of events or messages;
performing a batch notification of said contents of a certain number or a certain amount of events or messages as an interrupt;
preserving software execution environment directly before said interrupt occurs;
performing a process in accordance with said contents of a certain number or a certain amount of events or messages; and
recovering said software execution environment directly before said interrupt occurs.

3. A batch interrupts handling program executed by a computer, comprising steps of:
holding contents of a certain number or a certain amount of events or messages;
performing a batch notification of said contents of a certain number or a certain amount of events or messages as an interrupt;
preserving software execution environment directly before said interrupt occurs;
performing a process in accordance with said contents of a certain number or a certain amount of events or messages; and
recovering said software execution environment directly before said interrupt occurs.

4. A virtual shared memory comprising:
means for extracting a read side thread program and a write side thread program from a program for performing a read operation and a write operation; and
means for performing a synchronization control between said read side thread program and said write side thread program for a write side thread and a read side thread executed on the same processor or on different processors from each other in accordance with the relation between said write side thread and said read side thread on the basis of said read operation and said write operation.

5. The memory according to claim 4, wherein said read operation and said write operation are handled as a read event and a write event, respectively.

6. The memory according to claim 4 or 5, wherein said read thread program and said write thread program are respectively converted from existing program codes by a language processing system, and thereafter are formed into a read thread program and a write thread program having forms suitable for performing respectively a read operation and a write operation by means of said same processor or different processors from each other.

7. A virtual shared storing method comprising steps of:
extracting a read side thread program and a write side thread program from a program for performing a read operation and a write operation; and
performing a synchronization control between said read side thread program and said write side thread program for a write side thread and a read side thread executed on the same processor or on different processors from each other in accordance with the relation between said write side thread and said read side thread on the basis of said read operation and said write operation.

8. The method according to claim 7, wherein said read operation and said write operation are handled as a read event and a write event, respectively.

9. The method according to claim 7 or 8, wherein said read thread program and said write thread program are respectively converted from existing program codes by a language processing system, and thereafter are formed into a read thread program and a write thread program having forms suitable for performing respectively a read operation and a write operation by means of said same processor or different processors from each other.

10. A virtual shared storing program executed by a computer, comprising steps of:
extracting a read side thread program and a write side thread program from a program for performing a read operation and a write operation; and
performing a synchronization control between said read side thread program and said write side thread program for a write side thread and a read side thread executed on the same processor or on different processors from each other in accordance with the relation between said write side thread and said read side thread on the basis of said read operation and said write operation.

11. The program according to claim 10, wherein said read operation and said write operation are handled as a read event and a write event, respectively.

12. The program according to claim 10 or 11, wherein said read thread program and said write thread program are respectively converted from existing program codes by a language processing system, and thereafter are formed into a read thread program and a write thread program having forms suitable for performing respectively a read operation and a write operation by means of said same processor or different processors from each other.

13. A multiple concurrent processing device comprising:
means for dividing an existing program into a plurality of thread programs by means of a language processing system;
means for holding an interrupt from outside during execution of said thread program; and
means for executing said interrupt after said thread program has been ended.

14. A multiple concurrent processing method comprising steps of:
dividing an existing program into a plurality of thread programs by means of a language processing system;
holding an interrupt from outside during execution of said thread program; and
executing said interrupt after said thread program has been ended.

15. A multiple concurrent processing program executed by a computer, comprising steps of:
dividing an existing program into a plurality of thread programs by means of a language processing system;
holding an interrupt from outside during execution of said thread program; and executing said interrupt after said thread program has been ended.
